(19) United States
(12) Patent Application Publication
(10) Pub. No.: US 2009/0090241 A1
(43) Pub. Date: Apr. 9, 2009

(54) GAS SEPARATION MEMBRANES CONTAINING A MICROPOROUS SILICA LAYER BASED ON SILICA DOPED WITH A TRIVALENT ELEMENT

(76) Inventors: Anne Julbe, Montpellier (FR); Didier Cot, Jacou (FR); Beatrice Sala, St Gely Du Fesc (FR); Camelia Barboiu, Montpellier (FR)

Correspondence Address: SUGHRUE MION, PLLC, 2100 PENNSYLVANIA AVENUE, N.W., SUITE 800, WASHINGTON, DC, 20037, US

(21) Appl. No.: 12/158,410

(22) PCT Filed: Dec. 22, 2006
(86) PCT No.: PCT/FR06/02858

§ 371 Date: Sep. 3, 2008

(30) Foreign Application Priority Data
Dec. 22, 2005 (FR) 0513150

(51) Int. Cl. B01D 53/22; B05D 3/02; G21C 7/32

(52) U.S. Cl. 95/53; 96/11; 427/243; 376/210

(57) ABSTRACT

The subject of the present invention is a method for producing a gas separation membrane, comprising the deposition of a film from a silica sol onto a porous support followed by heat treatment of the film thus deposited, in which the silica sol deposited is prepared by hydrolysing a silicon alkoxide in the presence of a doping amount of a precursor of an oxide of a trivalent element, especially boron or aluminium. The invention also relates to the membranes as obtained by this method, and also to their uses, especially for the separation of helium or hydrogen at high temperature, and in particular for removing impurities in helium streams.

The present invention relates to ceramics membranes, which are suitable especially for the separation of gases by molecular sieving. More specifically, the invention relates to a process which permits the deposition on a porous support of a microporous layer based on amorphous silica which is substantially free of defects and is stable at high temperature, thus yielding membranes which are capable of ensuring efficient separation of gases such as He or H₂ at temperatures of the order of from 300 to 500° C.

The separation of gases by means of membranes is a technique which is widely used in the chemical industry and which has especially been developed during the past 25 years. Depending on the nature and structure of the membrane used (polymer, ceramics, dense or porous), various mechanisms of transport and separation are involved. Molecular sieving is a technique which consists in separating gases that are present as a mixture by using the difference in the kinetic radii of the molecules to be separated. To that end there is used a microporous membrane which, under the effect of a difference in concentration or partial pressure on either side of the membrane, preferentially allows the molecules having the smallest kinetic radius to diffuse and retains the molecules of larger size. Within this context, the membrane is used as a molecular sieve, employing a process of pore size exclusion which inhibits or retards the diffusion of the molecules of large size, thus favouring the diffusion of the molecules of the smallest size. Furthermore, in certain cases, adsorption phenomena (at the surface of the membrane and/or in its pores) can likewise contribute to the separation. For further details regarding this technique, reference can be made especially to “Fundamentals of inorganic membrane science and technology”, A. J. Burggraff and L. Cot, Elsevier, 1996.

The above-mentioned technique of transmembrane gas separation is found to be very advantageous, especially in so far as it is modular and can be used in a continuous manner. Especially, it constitutes a very interesting alternative to the other separation processes, such as the processes of cryogenics or adsorption, compared with which it is found to be simpler to carry out and less expensive. Accordingly, this technique has many fields of application in practice. Inter alia, it is used for the separation of O₂ and N₂ from air, for the extraction of H₂ and N₂ from gases for NH₃ production, or alternatively of H₂ from hydrocarbon-based effluents such as those obtained from refining processes, or alternatively for eliminating CO₂ or NO from various gaseous effluents. The efficiency of a gas separation by means of a membrane is limited by two parameters, namely:

(i) the capacity of the membrane used to allow the molecules of small size to diffuse; and
(ii) the capability of the membrane to block the molecules of larger size.

The first parameter (i) is expressed by the “permeability” of the membrane, namely the quantity of gas which is allowed to diffuse by the membrane per unit surface area and time, as a function of the applied pressure (expressed as mol.m⁻².s⁻¹.Pa⁻¹).

The second parameter (ii) is reflected by the “selectivity” of the membrane, which is calculated by the ratio (in moles) of the quantity of molecules of small size (the diffusion of which is desired) to the quantity of molecules of larger size (which are supposed to be retained) which are contained in the gaseous mixture which is allowed to diffuse by the membrane.

The lower the hydrodynamic diameter of the gases to be separated, the more difficult it is to obtain membranes having a high separation efficiency in terms of permeability and selectivity. Accordingly, the gas separation technique is found to be especially tricky when it is desired to effect the separation of helium (kinetic diameter below 0.30 nm) or of gases having similar kinetic diameters, such as H₂ or H₂O, or their deuterated or tritiated derivatives.

Within that context it is necessary to use membranes that comprise a separation layer having pores of extremely small size, generally less than 1 nm, in a sufficient number to permit the obtainment of good permeation. Membranes of that type, comprising layers having a pore diameter below 1 nm, are known at present.

As membranes of that type there may be mentioned especially membranes that comprise a dense or microporous layer, such as a microporous layer based on silica (which layer is generally designated MMS, “molecular sieve silica”).

Such membranes including a microporous layer based on silica are generally obtained by depositing a film of a silica sol on a porous support (for example an alumina-based support) and then subjecting the resulting film to thermal treatment in order to convert it into a microporous ceramics layer of silica. The silica sol used within this context is generally obtained by the so-called “sol-gel” technique, namely by hydrolyzing a silicon alkoxide, typically a tetraalkoxysilane such as TEOS (tetraethoxysilane, of the formula Si(OEt)₄), which leads to the formation of silanol species which polymerize to form silica clusters, which then condense to form a high-viscosity sol of the gel type. Such a method for depositing a thin layer of silica from a silica precursor of the silicon alkoxide type has been widely described in the literature, especially in the above-mentioned work “Fundamentals of inorganic membrane science and technology”, Elsevier, 1996, chapter 8 (p. 259).

A major problem that is encountered with membranes including microporous silica-based layers of the above-mentioned type is their propensity for the presence of defects, which affect the selectivity of the membrane. Such defects are principally associated with the rigidity of the silica lattice, which is a source of the formation of cracks when the layer is subjected to stress (which is especially the case with the membranes of large size which are necessary for gas separations on an industrial scale) and/or when it is deposited on a support having surface irregularities (which is almost always the case). The cracks so formed impair the selectivity of the membrane considerably in so far as the gases preferentially diffuse in the region of the cracks rather than through the pores, the nature of the cracks being such that they permit the diffusion of species having a larger kinetic diameter than the species to be separated. In order to obtain high selectivity it is found to be necessary to eliminate the phenomenon of cracking, and more generally the formation of defects, as far as possible.

One solution which has been proposed for limiting the phenomena of cracking in microporous silica layers obtained by the sol-gel route consists in replacing all or part of the tetraalkoxysilanes used as silica precursors by alkoxysilanes carrying at least 4 reactive groups of the alkoxy type. Within that context it has typically been proposed to replace all or part of the TEOS by alkyltrialkoxysilanes such as methyltriethoxysilane (MTES, of the formula Si(CH₃)(OEt)₃). The use of such silanes carrying non-reactive groups leads to a lowering of the degree of crosslinking of the resulting silica lattice as compared with the use of precursors of the TEOS type, in so far as the non-reactive groups (of the alkyl type) do not take part in the polymerization between the silanol species. Accordingly, a lowering of the rigidity of the layer of silica that is deposited, and consequently a reduction in its tendency to cracking, is obtained. Such a solution has been described especially in Sol-Gel Sci. Technol., 3, 47 (1994) or alternatively in Thin Solid Films, 462-463 (2004).

Nevertheless, the use of alkyltrialkoxysilanes of the MTES type is found to be of interest only for gas separations at low temperature. On the contrary, it is generally found to be unsatisfactory when the microporous layer must be used at high temperature, especially at temperatures greater than 200° C., and more so at temperatures greater than 250° C. In fact, the microporous silica layers which are obtained starting from alkyltrialkoxysilanes of the MTES type specifically comprise alkyl groups within their structure. Under the effect of an increase in temperature in the above-mentioned ranges, those groups oxidize and are extracted with the elimination of CO₂, which leads to the appearance of additional porosity in the layer, generally associated with embrittlement of the layer, which may induce cracking. These various phenomena are prejudicial to the selectivity of the gas separation. Especially, membranes based on a layer obtained from MTES are generally not suitable for the efficient separation of helium or H₂ at temperatures of the order of from 300° C. to 500° C., especially under pressure.

A solution which allow to obtain microporous layers of silica with a low degree of crosslinking, allowing membranes to be obtained which are suitable for the efficient separation of hydrogen or helium with good selectivity, has been described in application US 2004/00380044. In that document there is proposed a process for the synthesis of silica which is carried out according to a catalyzed sol-gel process in two steps, wherein the dilution conditions are managed in order to avoid the appearance of cracking during heat treatment of the layer. However, that process is found to be difficult to carry out in so far as it involves the fine control of a large number of parameters for the preparation of the silica layer.

An object of the present invention is to provide a novel process permitting the obtainment of gas separation membranes which are capable of ensuring the separation of helium or hydrogen at a temperature greater than 200° C., especially at temperatures of the order of from 300 to 500° C., with a permeability and selectivity which are preferably at least as good as, and advantageously superior to, those of the separation membranes known at present. Within that context the invention aims especially to provide membranes having such permeability and selectivity properties without having to employ the specific process described in US 2004/00380044.

To that end, the present invention relates to a process for the preparation of a gas separation membrane, comprising the deposition of a film of a silica sol on a porous support and then thermal treatment of the film so deposited, characterized in that the silica sol which is deposited in the form of a film on the porous support is prepared by hydrolyzing a silicon alkoxide in the presence of a doping amount of a precursor of an oxide of a trivalent element, the precursor being, for example, an alkoxide or alternatively an acid of the trivalent element.

Within the scope of the present description, “trivalent element” is understood as being an element whose atoms are capable of inserting themselves into the silica lattice with a degree of crosslinking of not more than 3. The trivalent element used according to the present invention is boron (B). Boron is generally used as the only trivalent element. However, boron can alternatively be used in admixture with other trivalent elements, for example aluminum.

Within the scope of the present description, the expression “precursor of an oxide of a trivalent element” denotes a compound which is capable of forming an oxide based on the trivalent element under the conditions of hydrolysis of the silicon alkoxide, which, in the process of the invention, allows the trivalent element to be incorporated into the silica lattice as it forms.

The precursor used to that end is in most cases an alkoxide of the trivalent element.

Accordingly, in its most general form, the process of the present invention comprises preparing the membrane according to a conventional sol-gel technique but specifically carrying out the hydrolysis of the silicon alkoxide with the additional presence of a precursor of an oxide of a trivalent element.

The alkoxide of a trivalent element that is used is generally introduced into the silicon alkoxide hydrolysis medium in the form of at least one compound corresponding to formula (I) below:

M(OR)₃ formula (I)

wherein:
M denotes boron (B); and
the 3 groups R are identical or different (generally identical) and each represents a hydrocarbon chain containing from 1 to 8 carbon atoms, preferably an alkyl group, preferably containing from 2 to 4 carbon atoms.

According to a particular variant, the alkoxide of a trivalent element that is used can be formed in situ in the silicon alkoxide hydrolysis medium. Within that context there can typically be introduced into the silicon alkoxide hydrolysis medium boron oxide B₂O₃ and an alcohol of the formula ROH, wherein R has the meaning given above, whereby the boron oxide and the alcohol react in situ to form a boron oxide precursor, of the boron alkoxide type, which is capable of leading to the incorporation of boron into the silica matrix as it forms. In the same manner, alumina Al₂O₃ can be introduced conjointly with an alcohol ROH to form in situ a precursor of the aluminum alkoxide type, permitting the incorporation of aluminum into the silica matrix as it forms.

As the precursor of an oxide of a trivalent element there can also be introduced into the silicon alkoxide hydrolysis medium an acid of the trivalent element, for example at least one compound having the formula (I′) below:

M(OH)₃ (I′)

wherein M denotes boron (B).

In the sense in which it is used in the present description, the term “precursor of an oxide of a trivalent element of the alkoxide type” encompasses such an acid.

Whichever manner it is introduced, the trivalent element used according to the invention is introduced into the silica-forming medium in a doping amount. Accordingly, silica generally remains the major constituent in the silica layer that is deposited. Within that context, the precursor of an oxide of the trivalent element is in most cases introduced into the silica-forming medium in a molar ratio trivalent element/silicon of less than 1:1 (100%), and in most cases less than 1:2, that ratio generally being greater than 1:100 (1%). Especially in order to obtain the greatest possible reduction in the cracking tendency, it is in most cases found to be advantageous for that ratio to be at least 1:20 (5%), more preferably at least 1:10 (10%), for example at least 1:5 (20%). Accordingly, the molar ratio (trivalent element/silicon) in the silica-forming medium can advantageously be from 1% to 50%, typically from 5% to 40%, for example from 10% to 30%. The molar ratio (boron/silicon) in the silica-forming medium is advantageously within the above-mentioned range.

The inventors have now evidenced that, when there is deposited on a porous support a silica sol prepared by the sol-gel process in the presence of a precursor of an oxide of a trivalent element of the alkoxide type of the above-mentioned type, a membrane is obtained in which the presence of cracks is substantially inhibited in the microporous silica layer. There is thus obtained a membrane permitting the separation of He or H₂ from gaseous mixtures containing them with relatively high selectivities. In addition, it is found that the high selectivity so obtained remains considerable at high temperature, especially at temperatures greater than 250° C., and even at temperatures of the order of from 300 to 500° C. Moreover, that high separation selectivity can, surprisingly, be achieved with very small thicknesses of the silica layer, which allows very high permeabilities for gases such as hydrogen or helium to be obtained at the same time. Accordingly, the process of the invention yields membranes whose permeation permits the obtainment of very efficient separations of gases such as He or H₂ at high temperature, with permeabilities which can reach values of the order of 10⁻⁶ mol.m⁻².s⁻¹ Pa⁻¹.

Without wishing to be bound by a particular theory, the above advantages seem to be due at least partly to the fact that the introduction of the trivalent element into the silica lattice induces a reduction in its degree of crosslinking and, consequently, a reduction in its rigidity analogous to that observed at low temperature using alkyltrialkoxysilanes of the MTES type. However, unlike in the case of the alkyltrialkoxysilanes, the solution proposed within the scope of the present invention does not involve the introduction of organic species within the silica lattice, which species are pyrolyzed at high temperature and affect the properties of the membrane, especially by creating porosity. Accordingly, it is possible with the process of the invention to obtain advantages similar to those obtained with the use of alkyltrialkoxysilanes of the MTES type while additionally allowing the membrane to be used at higher temperatures. It is to be noted in this respect that the process of the invention is generally carried out using tetraalkoxysilanes of the TEOS type, with the exception of silanes carrying non-reactive groups of the alkyltrialkoxysilane type.

This possibility of use at high temperatures is especially surprising in the case of the use of boron as the trivalent doping element. Boron is generally known as a vitrifying element, and accordingly it would rather have been expected that its incorporation into the silica would induce a reduction in the thermal stability of the microporous ceramics layer, detrimental to the separation of gases such as He or H₂.

In addition, the inventors have demonstrated that the process of the invention allows those improvements in the membrane to be obtained in a very simple and reproducible manner.

Very generally, the process of the invention can be carried out by employing the processes currently known for the deposition of layers of silica on porous supports using the sol-gel process, subject to the additional introduction into the silicon alkoxide hydrolysis medium of a precursor of an oxide of a trivalent element so as to dope the silica formed with said trivalent element.

According to a especially interesting embodiment, the process of the invention comprises the following successive steps:

(A) there is produced according to the sol-gel technique a sol of silica doped with said trivalent element, by hydrolyzing a silicon alkoxide (typically TEOS) in an aqueous, generally aqueous-alcoholic, medium containing a doping amount of a precursor of an oxide of the trivalent element;
(B) the sol so prepared is deposited on a porous support; and
(C) the film so deposited is subjected to thermal treatment, whereby it is converted into a microporous ceramics layer based on silica doped with the trivalent element.

Step (A) of preparation of the doped silica sol can be carried out under conditions known per se for the preparation of such sols. In general, this step is carried out by reacting the silicon alkoxide and the precursor of an oxide of the trivalent element in an aqueous-alcoholic medium at a pH suitable for the hydrolysis of those two compounds. Step (A) is carried out in an acidic medium, typically at a pH below 2, preferably below 1. That pH range is advantageously obtained by introducing a strong mineral acid such as nitric acid or hydrochloric acid into the medium.

Step (A) is additionally advantageously carried out under conditions which initially permit the solubilization of the various reagents that are present. To that end, step (A) is especially in most cases carried out in an aqueous-alcoholic medium preferably containing an alcohol selected from methanol, ethanol and propanol. In that aqueous-alcoholic medium, the mass ratio water/alcohol is typically from 1:5 to 5:1, for example from 1:3 to 3:1. Within that context, when an alkoxide of the trivalent element, especially a boron alkoxide, is used as the oxide precursor, it is especially advantageous to use, as the alcohol, an alcohol having substantially the same number of carbon atoms as the chains carried by the alkoxide, which especially allows the solubilization of the alkoxide to be optimized. Within that context, there is advantageously used an alkoxide (I) of the formula M(OR)₃ as defined hereinbefore, and an alcohol of the formula ROH, wherein the R groups in the alcohol and the alkoxide (I) are identical.

In addition, in the medium of step (A), the concentration of silicon alkoxide (TEOS, for example) is typically from 0.3 to 4 mol/litre, that concentration advantageously being below 3 mol/litre, preferably below 2 mol/litre. Advantageously, that concentration is at least 0.5 mol/litre, which especially allows the thermal treatment step (C) to be facilitated. Concentrations below 1.5 mol/litre, for example from 0.5 to 1 mol/litre, generally result in an optimal structure of the silica-based microporous layer formed in step (C).

In the particular case of the use of boron as the trivalent doping element, step (A) is advantageously carried out by introducing boron oxide B₂O₃ (typically in powder form) into an aqueous-alcoholic medium (advantageously based on ethanol) containing a silicon alkoxide (generally a tetraalkoxysilane, for example TEOS) and adjusted to a pH below 2, typically below 1. According to this specific variant, the B₂O₃ that is introduced is converted in situ into boron alkoxide, which then takes place in the hydrolysis and condensation reactions with the silicon alkoxide, whereby there is obtained an acidic sol of silica doped with boron within its lattice. Within that context, the reaction is preferably carried out at a temperature above 15° C., for example from 20 to 50° C., typically at a temperature below 40° C., which allows the initial conversion of the boron oxide into alkoxide to be optimized, in order to obtain efficient incorporation of boron into the silica lattice rather than physical inclusions of B₂O₃ in the structure of the silica.

Whatever the conditions employed, step (A) results in the formation of a sol of doped silica, the viscosity of which permits deposition in the form of a film on a porous support in step (B). The viscosity can be modulated by altering the duration and temperature of the sol formation, the gelification and viscosity increasing with the ageing time and with temperature. The technique used for the deposition of the film in step (B) depends on the nature of the porous support on which said film is to be deposited.

As a function of the intended application of the membrane prepared according to the invention, the support can especially be flat or tubular. In the case of a flat support, the deposition of step (B) is generally carried out by the so-called “spin coating” technique. In the case of a tubular support, the deposition of step (B) is carried out by the so-called “slip casting” technique. Those two techniques, which are well known, have been described especially in the above-mentioned work “Fundamentals of inorganic membrane science and technology”, Elsevier, 1996, p. 183. In the case of a tubular support, the deposition of step (B) can be carried out on the outside surface and/or on the inside surface, depending on the intended application.

A very simple method for carrying out the deposition of step (B) comprises immersing the porous support in the sol of doped silica. As well as being very easy to carry out, this embodiment surprisingly results especially efficient anchoring of the silica layer to the porous support. Without wishing to be bound to a particular theory, it may be supposed that the immersion of the support in the sol allows the presence of gases between the porous support and the silica layer that is forming to be substantially eliminated, which allows inhibition of the phenomena of separation of the silica layer which are observed during the thermal treatment of step (C) when air remains present in the pores of the porous support.

The porous support used in step (B) can be any porous support suitable for the preparation of gas separation membranes. In most cases, the deposition of step (B) is carried out on a support comprising a porous alumina on the surface on which the deposition is carried out. According to an interesting embodiment, for example, the support of step (B) comprises a sub-layer based on alpha-alumina (generally having a thickness of several tens or hundreds of microns) on which there is deposited a surface layer of gamma-alumina (generally a mesoporous layer having a thickness of the order of several microns) which is to receive the microporous layer based on doped silica that is deposited according to the invention.

Within the scope of the present invention, the inventors have furthermore evidenced that step (B) of the process (and, more widely, any step of deposition of the sol of doped silica on a porous support) can be optimized in order to improve the cohesion of the layer of doped silica on the porous support.

To that end, the work carried out by the inventors demonstrates that it is found to be especially interesting to carry out pretreatment of the support before step (B) in order to increase its affinity for the film that is deposited.

Within that context it is especially advantageous to carry out, before step (B), a step (A-a) of pretreatment of the surface of the support in order to confer thereon opposite surface charges to those of the doped silica of the sol used in the film deposited in step (B). In the case of the deposition of an acidic sol of doped silica, that step (A-a) of pretreatment of the surface will typically be carried out by means of a base, typically ammonia (which will be removed during the thermal treatment of step (C)). On the other hand, with a basic sol, it is expedient to treat the support with an acid, advantageously with an acid that can be removed during step (C), typically with hydrochloric acid or nitric acid. In all cases, step (A-a) is typically carried out by immersion. Accordingly, for example, in the case of the deposition of an acidic sol of doped silica on a support having an alumina-based surface layer, step (A-a) prior to step (B) can typically be carried out by impregnating the alumina-based support with an aqueous solution having a pH greater than the isoelectric point of the alumina. Because the isoelectric point is generally of the order of 9, the pH of the solution for treating the alumina-based surface is advantageously greater than 10, for example between 10, typically of about 10.5.

Another means of increasing the cohesion, of more mechanical nature, has also been evidenced by the inventors. Within that context, the inventors have observed that the elimination of the solvent present in the sol deposited in step (B) tends to separate the silica layer from the support, by a kind of peeling effect. In order to avoid this phenomenon, the process of the invention advantageously comprises, prior to the deposition of the film of step (B), a step (A-b) of pre-impregnation of the porous support with the silica sol prepared in step (A), followed by rinsing of the surface of the support and then thermal treatment of the support so rinsed. Within that context, the pre-impregnation of step (A-b) is advantageously carried out by totally immersing the porous support in the silica sol, which permits especially efficient impregnation of the pores of the support. By carrying out the above-mentioned step (A-b), there is obtained, during the subsequent thermal treatment of step (C), not only a surface layer based on doped silica but a layer that is anchored mechanically in the pores of the porous support, which prevents the phenomena of peeling of the layer of silica. The pre-impregnation according to step (A-b) is found to be especially efficient with mesoporous supports, namely supports having pores of a size typically from 2 to 50 nm.

According to a especially interesting embodiment, the process of the invention comprises both the above-mentioned steps (A-a) and (A-b). In that case, step (A-a) is preferably carried out prior to step (A-b).

In order further to improve the cohesion between the silica layer and the porous support, it is generally advantageous to carry out thermal pretreatment of the porous support prior to step (A) and the optional steps (A-a) and (A-b), more especially when the porous support is based on alumina. Within that context, the thermal pretreatment of the support is typically carried out at a temperature greater than 500° C., for example of the order of 600° C.

Step (B) of the process according to the invention is advantageously followed by a step of drying the film deposited on the support prior to step (C), which especially allows the cohesion between the deposited layer of silica and the support to be improved further. Drying is generally carried out by leaving the liquid film deposited on the support for from 5 to 15 hours, typically from 6 to 10 hours, at a temperature advantageously from 60 to 70° C., typically at a temperature of the order of 65° C.

Finally, step (C) of the process according to the invention comprises thermal treatment, which allows the film deposited in step (B) to be converted into a microporous ceramics layer based on doped silica. This thermal treatment step can be carried out under the conventional conditions employed for the preparation of gas separation membranes. Typically, the thermal treatment is carried out at a temperature of from 300 to 600° C., generally below 400° C. (from 500 to 600° C., for example) for a period of several hours (typically of the order of 2 hours).

Especially in order to avoid embrittlement of the deposited layer and in order to obtain homogenous pore size distribution, it is preferably expedient to carry out the thermal treatment with low rates of temperature rise and fall, typically of the order of from 0.1 to 5° C. per minute, preferably less than 2° C. per minute, for example from 0.5 to 1.5° C. per minute, and typically of the order of 1° C. per minute.

Following the various steps mentioned above, there is obtained, within the scope of the invention, a membrane suitable for the separation of gases, comprising a microporous layer of silica doped with a trivalent element deposited on a porous support.

The membranes of that type which can be obtained by the process of the invention constitute another specific object of the present invention.

It is to be noted that, according to the particular embodiment in which the trivalent doping element used is boron, the process of the present invention yields novel membranes comprising a microporous layer of silica doped with boron, deposited on a microporous support. To the inventors' knowledge, such membranes have never been described and, as such, they constitute another object of the present invention.

The microporous layer based on doped silica that is present in the membranes of the present invention is generally a fine layer having a thickness of from 50 to 500 nm, typically from 100 to 300 nm.

The process of the invention additionally permits the obtainment of microporous layers based on doped silica that are free of defects, even when the support used is of large size.

The microporous layer based on doped silica that is present in the membranes of the invention is in most cases constituted substantially (or even exclusively) by said doped silica, with the exception of other functional groups or compounds. Especially, the microporous layer based on doped silica of the membranes of the invention is generally free of organic groups of the type observed in the silica layers obtained by sol-gel processes using alkyltrialkoxysilanes such as methyltriethoxysilane.

Preferably, the microporous layer based on doped silica that is present in the membranes of the present invention contains pores less than 1 nm in size. To that end it is preferable to use in the process a sol of doped silica in which the silica is dispersed in the form of suspended objects (particles or aggregates of particles) having hydrodynamic diameters less than 10 nm. The conditions to be employed in step (A) to obtain such sols are illustrated in the examples hereinbelow.

The membranes of the invention advantageously comprise their layer of doped silica on an alumina-based support of the type described above in the present description. In most cases, the silica layer is a surface layer of the membrane. However, for certaespecially applications, the layer of silica deposited according to the process of the invention can subsequently be covered by another porous or quasi-dense layer (or even by a plurality of other layers), for example by a covering layer based on silicon carbide, permitting the separation of water, for example.

According to another embodiment, the membranes of the invention can contain a plurality of successive layers of doped silica, typically obtained by repeating steps (A), (B) and (C).

In view of their particular characteristics, the membranes of the invention are especially suitable for the separation of gases, and especially for the separation of helium or hydrogen from gaseous mixtures comprising them, especially at temperatures greater than 250° C., for example at temperatures of the order of from 300 to 500° C., generally with transmembrane pressures below 8 bar. Within that context, it may be advantageous to subject the membrane to thermal pretreatment before the gas separation, typically at a temperature above or equal to 400° C., for example from 500 to 600° C. That specific application constitutes another object of the present invention.

According to a first embodiment, the membranes of the invention comprise the microporous layer of doped silica deposited on a flat support. In this form, they are capable of effecting the separation of gases as filters separating two cavities. Within this context, they are advantageously in the form of plates or disks.

According to another embodiment, which is generally more interesting, the membranes of the invention comprise the microporous layer of doped silica deposited on the inside or outside surface of a cylindrical support. Such membranes are suitable for the separation of gases in a continuous manner.

The membranes in which the microporous layer of doped silica is deposited on the inside surface of the cylindrical support are generally used by circulating a gaseous mixture containing the gases that are to be extracted in the inner space of the cylinder, with a partial pressure of the gases that are to be extracted that is greater in the inner space than on the outside of the cylinder. According to this embodiment, it is possible, for example, to purify a gaseous stream of helium or hydrogen containing impurities, the helium or hydrogen being evacuated outside the cylinder and the impurities remaining trapped therein.

By contrast, the membranes comprising the microporous layer of doped silica on the outside surface of the cylindrical support are intended to be used by circulating the gaseous mixture containing the gases that are to be extracted outside the cylinder and circulating in the inner space of the cylinder a stream of the gases that are to be extracted with a reduced partial pressure as compared with the outside. According to this embodiment, the gases to be extracted are drawn into the cylinder while the gases to be separated off remain outside the cylinder. This embodiment is suitable especially for the extraction of gases that are present in small amounts in a gaseous stream (hydrogen in hydrocarbon-containing effluents, for example).

The membranes of the invention, especially those in which the microporous layer based on doped silica contains pores of a size smaller than 1 nm, are found to be especially suitable for the separation of helium or hydrogen from a mixture containing them.

Especially, the membranes of that type are very suitable for removing impurities from streams of helium.

Within that context, the membranes of the invention find a very valuable application in the treatment of the hot helium streams used especially in the primary circuits of the new generation of high-temperature nuclear reactors, known as HTRs. In those reactors, the impurities such as CO, CO₂ or CH₄, and the fission products of the type Xe or Kr that are present in the helium must be removed in so far as they are a source of corrosion. The membranes of the invention allow such a separation to be carried out efficiently at the working temperatures of the helium in the reactor (from 300 to 500° C. and under pressure). Within this context it is preferable to use membranes in which the microporous layer of doped silica is deposited on the surface of a cylindrical support, preferably on the inside surface, the membranes of the invention then allowing such a separation to be carried out continuously and efficiently and quantitatively, with permeabilities which can reach values of the order of 10⁻⁶ mol.m⁻².s⁻¹.Pa⁻¹ and with especially high helium separation selectivities.

Accordingly, this use of the membranes according to the invention constitutes a very interesting alternative to the current processes for purifying the helium circuits of HTR-type reactors, in which purification must be carried out discontinuously and at low temperatures reaching −180° C.

This particular application of the membranes according to the invention, and the nuclear installations comprising a helium coolant circuit equipped with a gas separation system using a gas separation membrane according to the invention for the purification of the helium, constitute other specific objects of the invention.

In addition to the specific applications mentioned above, the membranes of the invention are used in many fields, owing to their many advantages.

Especially, the membranes of the invention can be used for extracting hydrogen H₂ from gaseous mixtures containing it, such as effluents from oil refineries, or for removing gaseous pollutants present in a hydrogen stream, for example prior to its introduction into a synthesis reactor, or alternatively in fuel cells (especially of the PEM type), where they allow, inter a/ia, the removal of gases of the CO type which may poison the catalysts. The membranes of the invention also yield very good selectivities in the scope of such hydrogen separation processes.

More generally, the membranes of the invention can be used in many other fields in which the separation of gases is required, in so far as they constitute very valuable improvements to the membranes known at present. Especially, the membranes of the invention can potentially be used for the separation of hydrogen and of gases having a kinetic diameter greater than 0.30 nm, such as nitrogen, oxygen, carbon-containing gases (especially hydrocarbon-containing gases) or H₂S.

Various aspects and advantages of the invention will become even more apparent from the illustrative examples described hereinbelow.

### EXAMPLE 1

A membrane based on a microporous layer of silica doped with boron and deposited on an alumina-based support was prepared under the following conditions:

Preparation of a Sol of Silica Doped with Boron (Sol-Gel Technique)

In a two-necked flask equipped with a reflux column and placed in a heating bath at a temperature of 40° C., 1 mole of TEOS was introduced into a medium containing 4 moles of water and 4.5 moles of ethanol and 0.04 mole of hydrochloric acid. 0.1 mole of boron oxide B₂O₃ was introduced into that medium.

The resulting mixture was left under reflux at 40° C. for 3 hours.

At the end of this reaction there was obtained an acidic sol of doped silica (S) having a pH of 1 and a sufficiently low viscosity to carry out the following steps.

Pretreatment of the Alumina Support

The alumina support used in this example is an alumina-based support marketed by PALL EXEKIA in the form of a hollow cylinder (inside diameter: 7 mm, outside diameter: 10 mm; length: 25 cm) comprising an inside layer based on mesoporous gamma-alumina (pore diameter: 5 nm) deposited on the alpha-alumina constituting the outside of the cylinder.

The support had been subjected to thermal pretreatment at 600° C. (or even 550° C.) according to the following profile: rise in temperature at a rate of 1° C./minute to 600° C., maintenance at 600° C. for 2 hours, fall in temperature to ambient temperature at a rate of 1° C./minute.

The support subjected to thermal pretreatment in that manner was subsequently immersed in an aqueous ammonia solution of pH 10.5 for 30 minutes and then drained in order to obtain negative surface charges.

Pre-Impregnation of the Support

The support obtained in the preceding step was wholly immersed in the acidic sol (S) for 2 hours and the support so treated was then rinsed with ethanol.

The support was then dried by being left in an oven at 65° C. for 8 hours.

Following drying, the support was subjected to thermal treatment at 550° C. according to the following profile: rise in temperature at a rate of 1° C./minute, maintenance at 550° C. for 2 hours, fall in temperature at a rate of 1° C./minute.

Deposition of a Film of the Silica Sol on the Pretreated Support

The pretreated support obtained in the preceding steps was totally immersed for 2 hours in the sol (S) diluted with alcohol to ⅙ of its initial concentration.

The support was then removed from the sol and dried in an oven at 65° C. for 15 hours.

Following drying, the support covered with the film was subjected to thermal treatment under the following conditions:
rise in temperature from 20° C. to 100° C. at a rate of 1° C. per minute;
threshold: maintenance at 100° C. for 2 hours; and
rise in temperature to 550° C. at a rate of 1° C. per minute;
threshold: maintenance at 550° C. for 2 hours;
fall in temperature to 20° C. at a rate of 1° C. per minute.

Following these steps, a membrane (M1) according to the invention was obtained.

The membrane was tested by carrying out the separation of helium at 300° C. from a helium-based mixture containing 1% CO₂ and 1% CH₄, under the following conditions:
drying the support under helium at 250° C.;
temperature of the permeation test: 250° C. to 300° C.,
transmembrane pressure difference: 1 to 4 bar.

Helium separation with the following characteristics was obtained:
permeability: 10⁻⁶ mol.m⁻².s⁻¹.Pa⁻¹
He/CO₂ selectivity: 18
He/CH₄ selectivity: 21.

### EXAMPLE 2

In this second example, a membrane based on a double microporous layer of silica doped with boron, deposited on an aluminum-based support, was prepared under the following conditions:

### 2.1 Preparation of the Support

The alumina support used in this example is an alumina-based support marketed by PALL EXEKIA in the form of a hollow cylinder (inside diameter: 7 mm; outside diameter: 10 mm; length: 25 cm) comprising an inside layer based on mesoporous gamma-alumina (pore diameter: 5 nm) deposited on the alpha-alumina constituting the outside of the cylinder.

Thermal Pretreatment

The support was first subjected to thermal pretreatment in order to “open” the pores of the alumina. This treatment was carried out at 600° C. (or even 550° C.) according to the following profile: rise in temperature at a rate of 1° C./minute to 600° C., maintenance for 2 hours at 600° C., fall in temperature to ambient temperature at a rate of 1° C./minute.

Formation of an Intermediate Silica/Alumina Layer

Following the thermal treatment, the support was immersed in an aqueous ammonia solution of pH 10.5 for 30 minutes and was then drained.

The support was then immersed in a sol (S_{Si/Al}) of silica/alumina obtained by mixing:
1 mole of TEOS
4.5 moles of ethanol
0.04 mole of hydrochloric acid
4 moles of water
1.5 moles of boehmite (or even 1 to 2 moles)
   for from 2 to 5 hours.

The tube is washed with ethanol.

The support was then dried in an oven at 65° C. for 8 to 12 hours in the vertical position.

Following drying, the support was subjected to thermal treatment at 550° C. according to the following profile: rise in temperature at a rate of 1° C./minute, maintenance at 550° C. for 2 hours, fall in temperature at a rate of 1° C./minute.

Pre-Impregnation of the Support

Following the various steps above, the support was again immersed in an aqueous ammonia solution of pH 10.5 for 30 minutes and was then drained.

The support was then wholly immersed for 2 hours in the acidic sol (S) described in Example 1, and the support so treated was then rinsed with ethanol.

The support was then dried by being left in an oven at 65° C. for 8 to 12 hours.

Following drying, the support was subjected to thermal treatment at 550° C. according to the following profile: rise in temperature at a rate of 1° C./minute, maintenance at 550° C. for 2 hours, fall in temperature at a rate of 1° C./minute.

2.2 Deposition of the Double Layer of Silica Doped with Boron

Deposition of the First Layer

The pretreated support obtained in the preceding steps was totally immersed for 2 hours in the sol (S) diluted with alcohol to ⅙ of its initial concentration.

The support was again dried in an oven at 65° C. for 8 to 12 hours in the vertical position and was then subjected to thermal treatment at 550° C. (rise in temperature at a rate of 1° C./minute, maintenance at 550° C. for 2 hours, fall in temperature at a rate of 1° C./minute).

The deposition of a first microporous layer of silica doped with boron was thus obtained.

Deposition of the Second Layer

The covered support so obtained was totally immersed firstly for 3 minutes in ethanol and secondly for 2 hours in the sol (S) diluted with alcohol to 1/12 of its initial concentration.

Following this further immersion, the support was again dried in an oven at 65° C. for 12 hours in the vertical position and was then subjected to thermal treatment at 550° C. (rise in temperature at a rate of 1° C./minute, maintenance at 550° C. for 2 hours, fall in temperature at a rate of 1° C./minute).

Following these steps, a membrane (M2) according to the invention was obtained.

1.-19. (canceled)

20. A process for the preparation of a gas separation membrane, comprising a deposition of a film of a silica sol on a porous support and then thermal treatment of the film so deposited, wherein the silica sol which is deposited in the form of a film on the porous support is prepared by hydrolyzing a silicon alkoxide in the presence of a doping amount of a precursor of an oxide of a trivalent element, said trivalent element being boron.

21. The process of claim 20, wherein the precursor of boron oxide used is an alkoxide or acid of boron.

22. The process of claim 20, wherein the precursor of boron oxide used is introduced into the silicon alkoxide hydrolysis medium:
in the form of at least one compound having the formula (I) below:
M(OR)₃ formula (I)
or
in the form of at least one compound having the formula (I′) below:
M(OH)₃ formula (I′)
wherein:
M denotes boron; and
the 3 groups R are identical or different, each representing a hydrocarbon chain containing from 1 to 8 carbon atoms.

23. The process of claim 20, wherein the boron alkoxide is formed in situ by introducing into the silicon alkoxide hydrolysis medium boron oxide B₂O₃ and an alcohol of the formula ROH, wherein R represents a hydrocarbon chain containing from 1 to 8 carbon atoms.

24. The process of claim 20, wherein the boron oxide precursor is introduced in the silica-forming medium in a molar ratio trivalent element/silicon of from 1:100 to 1:1, preferably from 1:20 to 1:2.

25. The process of claim 20, which comprises the following successive steps:
(A) there is produced according to the sol-gel technique a sol of silica doped with said trivalent element, by hydrolyzing a silicon alkoxide in an aqueous-alcoholic medium containing a doping amount of a precursor of an oxide of boron;
(B) the sol so prepared is deposited on a porous support; and
(C) the film so deposited is subjected to thermal treatment, whereby it is converted into a microporous ceramics layer based on silica doped with boron.

26. The process of claim 25, wherein the concentration of silicon alkoxide in the medium of step (A) is from 0.3 to 4 mol/litre.

27. The process of claim 25, wherein step (A) is carried out by introducing boron oxide B₂O₃ into an aqueous-alcoholic medium containing a silicon alkoxide and is adjusted to a pH less than 2.

28. The process of claim 25, wherein the deposition of step (B) is carried out on a support comprising a porous alumina on the surface on which the deposition is carried out.

29. The process of claim 25, which comprises, prior to step (B), a step (A-a) of pretreating the surface of the support in order to confer thereon opposite surface charges to those of the doped silica of the sol used in the film deposited in step (B).

30. The process of claim 29, wherein the sol prepared in step (A) is an acidic sol of doped silica and wherein the support used in step (B) has an alumina-based surface layer, and in which step (A-a) is carried out by impregnating the alumina-based support with an aqueous solution having a pH greater than the isoelectric point of the alumina.

31. The process of claim 25, which comprises, prior to the deposition of the film of step (B), a step (A-b) of pre-impregnation of the porous support with the silica sol prepared by step (A), followed by rinsing of the surface of the support and then thermal treatment of the support so rinsed.

32. The process of claim 25, wherein step (B) is carried out by immersing the porous support in the sol.

33. A membrane comprising a microporous layer of silica doped with boron, deposited on a porous support, as obtained according to the process of claim 20.

34. A membrane suitable for the separation of gases, comprising a microporous layer of silica doped with boron, deposited on a mesoporous support.

35. A Membrane according to claim 34, wherein the microporous layer based on silica doped with boron has a thickness of from 50 to 500 nm.

36. A process of separation of helium or hydrogen from gaseous mixtures containing them, making use of a membrane according to claim 33 as a separation membrane.

37. The method of claim 36, wherein the separation is carried out at a temperature greater than 250° C.

38. A nuclear installation comprising a helium coolant circuit, equipped with a gas separation system for the purification of the helium using a membrane according to claim 33.

39. A nuclear installation comprising a helium coolant circuit, equipped with a gas separation system for the purification of the helium using a membrane according to claim 34.
